(19) United States
(12) Patent Application Publication
(10) Pub. No.: US 2006/0237390 A1
(43) Pub. Date: Oct. 26, 2006

(54) Combined Microscale Mechanical Topography and Chemical Patterns on Polymer Substrates for Cell Culture

(76) Inventors: William Paul King, Smyrna, GA (US); Andres Jose Garcia, Atlanta, GA (US); Joseph Leo Charest, Atlanta, GA (US); Nathan Daniel Gallant, Atlanta, GA (US)

Correspondence Address: TROUTMAN SANDERS LLP, 600 PEACHTREE STREET , NE, ATLANTA, GA, 30308, US

(21) Appl. No.: 11/279,808

(22) Filed: Apr. 14, 2006

Related U.S. Application Data
(60) Provisional application No. 60/671,230, filed on Apr. 14, 2005.

(51) Int. Cl. B44C 1/22; C23F 1/00

(52) U.S. Cl. 216/41; 216/52

(57) ABSTRACT

The invention is a method for fabricating a cell culture surface substrate, comprising the steps of a) forming a cell culture surface having a mechanical topography, b) forming a synthetic chemical pattern using a chemical pattern template, and c) combining the cell culture surface having a mechanical topography and the synthetic chemical pattern. Mechanical topography is defined as a pattern of mechanical structures with regular and specifically designed features. The synthetic chemical pattern is defined as a group of features of specific chemistry different from the chemistry of their surroundings that have regular and specifically designed features.

### RELATED U.S. APPLICATION DATA

This application claims the benefit of U.S. Provisional Application No. 60/671,230, filed Apr. 14, 2005, which is incorporated herein by reference.

### GOVERNMENT INTERESTS

The present invention was made with government support via NSF Career CTS-38888 and NIH R01-GM065918 grants. The government may have certain rights in this invention.

### FIELD OF THE INVENTION

The present invention relates to the fields of mechanical topography and chemical patterns on cell culture substrates. Specifically, the invention relates to microscale mechanical topography combined with chemical patterns on cell culture substrates.

### BACKGROUND OF THE INVENTION

The interactions between a cell surface substrate (e.g., orthopaedic implant material surface) and host cells play central roles in the integration, biological performance, and clinical success of implanted biomedical devices, including orthopaedic joint replacements, biosensors, and drug delivery devices. The mechanical topography and chemistry of an implant material surface can modulate cellular responses, including survival, adhesion, spreading, migration, proliferation, and expression of differentiated phenotypes via spatial presentation of bioadhesive ligands either absorbed from physiological fluids or engineered on the surface to convey biofunctionality.

Mechanical topography is a pattern of mechanical structures with regular and specifically designed size, shape, and periodicity and fundamentally differs from mechanical roughness, which is a group of mechanical features that exhibits randomness and polydispersity in size, shape, and periodicity. Many groups have examined the effect of mechanical topography on cellular activities using various substrate materials. Mechanical topography of cell culture substrates has been shown to influence cell morphology, morphology and migration, initial focal adhesion density and size, spreading, contact guidance, and differentiation. For example, Flemming et al., (the Flemming reference) discloses that topographical cues, independent of biochemistry, may have significant effects upon cellular behavior (Flemming, R. G. et al., Effects of synthetic micro- and nano-structured surfaces on cell behavior; Biomaterials 20(1999)). More specifically, the Flemming reference discloses that the topography of micro- and nano-structured surfaces (e.g., grooves, ridges, steps, pores, wells, nodes, and adsorbed protein fibers) as well as that of the vertebrate basement membrane affects cell alignment, proliferation, adhesion, and migration areas. The Flemming reference further hypothesizes that the topography of the basement membrane is important in regulating cellular behavior in a manner distinct from that of the chemistry of the basement membrane. Flemming is solely focused on the topic of topography.

A chemical pattern is a group of features of specific chemistry different from the chemistry of their surroundings that have regular and specifically designed size, shape, and periodicity. Surface chemical patterns can influence cellular responses such as adhesion, shape and function, attachment location, and can produce co-cultures of cells. For example, Chen et al., (the Chen reference) discloses micropatterned surfaces for control of cell characteristics (Chen, C. S., Micropatterned Surfaces for Control of Cell Shape, Position, and Function; Biotechnol. Prog.; 14(1998)). More specifically, the Chen reference discloses that microcontact printing of self-assembled monolayers of alkanethiolates on gold can be used to pattern cell types for long-term culture. The Chen reference is solely focused on certain chemical patterns.

While it is well established that microscale mechanical topography and chemical patterns can influence cell-substrate interactions, the interplay and relative impact of these two surface properties in regulating cellular activities remains poorly understood. Although some studies report on cell responses to mechanical topography for different surface chemistries, the chemical patterns in these studies have been defined by and concurrent with the mechanical topography. For example, Britland et al., demonstrated that nerve cell growth is influenced by the guiding properties of its substratum (Britland, et al., Morphogenic guidance cues can interact synergistically and hierarchically in steering nerve cell growth; Exp. Biol. Online 1:2(1996)). Specifically, the Britland reference discloses that rat dorsal root ganglia cells can detect and integrate simultaneous model adhesive and topographic guidance cues. The congruency of the mechanical and chemical influences in this study and others limits the interpretation of the data in one aspect; that is regarding the effects of the relative simultaneous influence of both types of patterns on cellular alignment.

Both mechanical topography and surface chemistry must be well controlled in order to fully understand and manipulate implant-cell interactions. Synthetic chemical patterns have not been independently combined with mechanical topography to manipulate cellular responses.

While there may be cellular behaviors that are exclusive to either chemical patterns or mechanical topography, certain responses such as surface-guided cell growth, known as contact guidance, are common to both. Although several groups have analyzed cellular alignment as a way of evaluating contact guidance due to mechanical topography and chemical patterns, the relative influence of the two types of patterns on cellular alignment is unknown when they are presented simultaneously. In addition, other methods of mechanical topography and chemical patterns are limited by compatibility with biomaterials and by the inability to scale up to larger surface areas. For example, the feature sizes may be only as small as 1 um, the substrate size may only be as big as four to six inches, and the type of substrate material that may be used is restricted. What is needed is a method to produce a cell culture substrate allowing features of arbitrary size, substrates of arbitrary size, and that expands the available substrates to include biomedical polymers.

### SUMMARY OF THE INVENTION

The invention is a method for fabricating a cell culture surface substrate, comprising the steps of a) forming a cell culture surface having a mechanical topography, b) forming a synthetic chemical pattern using a chemical pattern template, and c) combining the cell culture surface having a mechanical topography and the synthetic chemical pattern. Mechanical topography is defined as a pattern of mechanical structures with regular and specifically designed features. The synthetic chemical pattern is defined as a group of features of specific chemistry different from the chemistry of their surroundings that have regular and specifically designed features. In one embodiment, the invention is a biomedical polymer (i.e., synthetic polymeric materials for biomedical applications) having mechanical topography overlaid with chemical patterns by combining hot-embossing imprint lithography (HIL) with microcontact printing (μCP).

### BRIEF DESCRIPTION OF THE FIGURES

FIG. 1A is a scanning electron microscope (SEM) image of a substrate with combined mechanical topography and chemical patterns. Gold areas protected by the μCP HDTs are white, whereas unprotected areas that have been etched to the titanium layer are grey.

FIG. 1B is an immunofluorescence image of substrate with vertical grooves and horizontal fibronectin lanes. The chemical pattern can be varied independently of the mechanical topography.

FIGS. 2A and 2B are immunofluorescence images of cells on patterned substrates (FIG. 2A) with corresponding histograms of cell alignment angle (FIG. 2B). Grooves are vertical (0°) and lanes are horizontal (90°).

FIGS. 3A and 3B are immunofluorescence images of cells on patterned substrates (FIG. 3A) with corresponding histograms of cell alignment angle (FIG. 3B). Grooves are vertical (0°) and lanes are horizontal (90°).

FIGS. 4A and 4B are immunofluorescence images of cells on patterned substrates (FIG. 4A) with corresponding histograms of cell alignment angle (FIG. 4B). Grooves are vertical (0°) and lanes are horizontal (90°).

### DETAILED DESCRIPTION

The invention is a method for fabricating a cell culture surface substrate, comprising the steps of a) forming a cell culture surface having a mechanical topography, b) forming a synthetic chemical pattern using a chemical pattern template, and c) combining the cell culture surface having a mechanical topography and the synthetic chemical pattern. Mechanical topography is defined as a pattern of mechanical structures with regular and specifically designed features. Mechanical topography may include, for example, grooves of varying shape (square, V-shaped, U-shaped, and the like), mesas, ridges, wells, nodes, pillars, pores, spheres, and cylinders. The synthetic chemical pattern is defined as a group of features of specific chemistry different from the chemistry of their surroundings that have regular and specifically designed features. The list of synthetic chemicals and molecules that may be used to produce a synthetic chemical pattern is extensive and known to one of ordinary skill in the art, including for example, fibronectin, self-assembled monolayers (SAMs), glycols and their derivatives, and silanes and their derivatives.

To illustrate, features are designed onto a template used for synthetic chemical patterning (i.e., a chemical pattern template). The chemical pattern template features are coated with chemicals or biochemicals (hereafter “chemicals”). Everywhere the chemically-coated features touch the surface of the mechanical topography, the chemicals are transferred to the surface. Accordingly, the chemicals are transferred in the same pattern as the chemical pattern template. This chemical pattern is distinct from, and independent from, any topographical pattern that is already on the mechanical surface topography. This advancement in cell culture substrate fabrication allows chemical pattern geometry to be decoupled from the mechanical topography such that the mechanical topography neither determines nor limits the configuration of the chemical pattern.

In this regard, the inventors have discovered a method for fabricating cell culture substrates having mechanical topography overlaid with chemical patterns by combining hot-embossing imprint lithography (HIL) with microcontact printing (μCP). In addition to the advantage of independent manufacture of chemical pattern geometry and mechanical topography, the method of the invention allows the synergistic benefits of mechanical and chemical features of arbitrary size, substrates of arbitrary size, and expands the available substrates to include biomedical polymers.

Herein hot-embossing imprint lithography was utilized to produce microscale mechanical topography on the polymer substrates. Most previous work to fabricate microscale mechanical topography in polymer cell substrates used either casting or optical lithography, although a few studies used HIL. HIL is a high-temperature surface-forming process in which a micromachined master is pressed into a thermoplastic polymer at elevated temperature. HIL can replicate features as small as 10 mm and works for most thermoplastic polymers, and biodegradable polymers such as those used in tissue engineering scaffolds. To fabricate substrate microscale mechanical topography, a uniformly-heated temperature-controlled press embossed a microstructured silicon master into a film of uncured polyimide. The process resulted in a complete relief replication of the master in the polyimide with 8 μm wide grooves 4 μm deep separated by 16 μm wide mesas uniformly covering the 8 mm square substrate. Embossed substrates were cured and coated with 10 nm of titanium followed by 20 nm of gold to accommodate the chemical patterning.

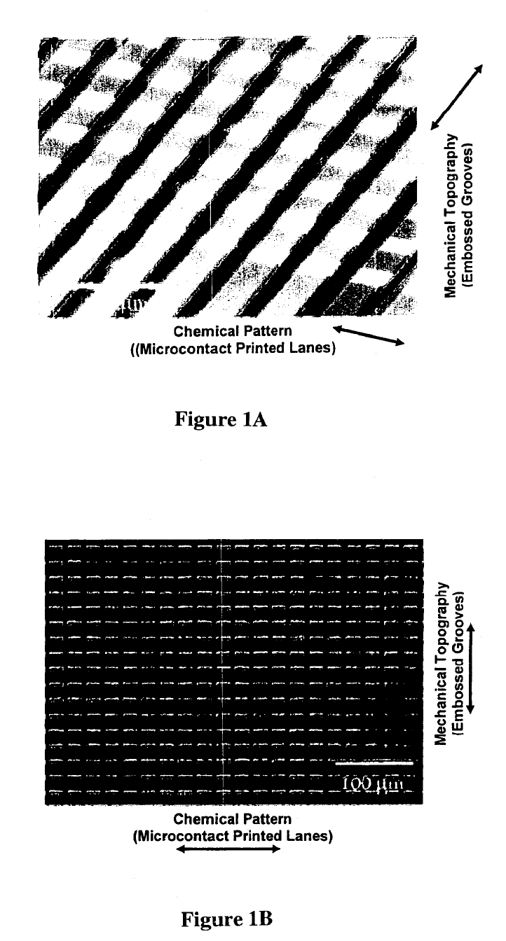

Microcontact printing (μCP) is preferably utilized to contact transfer a chemical pattern onto the substrate. Raised patterns on the stamp contact the surface and deposit chemicals while the recessed areas do not. Poly(dimethylsiloxane) (PDMS) stamps with the desired microscale chemical pattern were swabbed with hexadecanethiol (HDT), allowed to dry, then brought into contact with the gold-coated substrate. Both stamps and substrates had alignment marks to guide orthogonal alignment of the raised mesas of the stamp to the mechanical topography of the substrate. To characterize this patterning technique, embossed and printed substrates were etched in KCN to remove any gold not protected by the HDT. The resulting substrate had HDT-functionalized gold lanes where the stamp inked the substrate spaced by titanium areas that were not chemically printed. FIG. 1A shows an SEM image of the resultant etched substrate, providing a clear illustration of the combined mechanical topography and chemical patterning technique.

For cell culture substrates, HDT-terminated patterns were stamped, then the bare gold areas not printed were derivatized with a tri(ethylene glycol)-terminated alkanethiol (EG₃-thiol). Samples were incubated in a 10 μg/mL solution of fibronectin to coat the HDT-printed areas with this bioadhesive protein. The non-fouling properties of the EG₃-thiol prevented protein adsorption and these regions remained resistant to cell adhesion. As demonstrated by immunofluorescence staining for fibronectin in FIG. 1B, this approach resulted in a substrate with a chemical pattern of fibronectin-coated HDT lanes spaced by non-fouling EG₃-thiol domains that ran orthogonal to the mechanical topography of the embossed grooves. The breaks in the fibronectin lanes correspond to intersection with the 8 μm wide grooves.

Below is Table 1 which identifies certain results obtained from experiments. For the data obtained for Table 1 substrates had either topography, chemistry, or a combination of the two. The combination substrates had the same topography, with chemical patterns varyingly spaced from below that of the topography to larger than a spread cell. Cells aligned strongly to either mechanical topography or chemical patterns when presented separately. On all combined substrates, cells aligned to the mechanical topography rather than the chemical patterns. PEG=polyethylene glycol; SEMs=self-assembled monolayers.

TABLE 1

| | | | Average | Percentage |
|---|---|---|---|---|
| | Mechanical | | Alignment | Cells Aligned |
| Sample | Topography | Surface Chemistry | Angle | (within 10°) |
| Unpatterned | Smooth no | Uniform Fibronectin | 48.3° | *Alignment to |
| Control | mechanical | coating on CH₃ | *Alignment to | arbitrary |
| | patterns | terminated SAMs | arbitrary | reference |
| | | | reference | |
| Mechanical | Embossed | Uniform Fibronectin | 9.6° | 73.2% |
| Topography | 8 μm grooves | coating on CH₃ | | |
| Baseline | separated by | terminated SAMs | | |
| | 16 μm mesas | | | |
| Chemical Pattern | Smooth | Fibronectin Lanes | 81.9° | 80.6% |
| Baseline | no mechanical | 10 μm wide spaced | *Alignment to | *Alignment to |
| | patterns | by 20 μm wide lanes | fibronectin | fibronectin |
| | | of PEG terminated | lanes | lanes |
| | | SAMs | | |
| Combined 10 | Embossed | Fibronectin Lanes | 12.4° | 65.9% |
| | 8 μm grooves | 10 μm wide spaced | | |
| | separated by | by 10 μm wide lanes | | |
| | 16 μm mesas | of PEG terminated | | |
| | | SAMs | | |
| Combined 20 | Embossed | Fibronectin Lanes | 11.9° | 67.1% |
| | 8 μm grooves | 10 μm wide spaced | | |
| | separated by | by 20 μm wide lanes | | |
| | 16 μm mesas | of PEG terminated | | |
| | | SAMs | | |
| Combined 50 | Embossed | Fibronectin Lanes | 13.7° | 54.0% |
| | 8 μm grooves | 10 μm wide spaced | | |
| | separated by | by 50 μm wide lanes | | |
| | 16 μm mesas | of PEG terminated | | |
| | | SAMs | | |
| Combined 100 | Embossed | Fibronectin Lanes | 12.2° | 62.4% |
| | 8 μm grooves | 10 μm wide spaced | | |
| | separated by | by 100 μm wide | | |
| | 16 μm mesas | lanes of PEG | | |
| | | terminated SAMs | | |

Substrates were prepared with mechanical topography only, chemical patterns only, or a combination of overlaid mechanical topography and chemical patterns. Table 1 lists all configurations of substrates. The spacing of the grooves, 16 μm, was chosen to be less than the diameter of a spread cell (30-50 μm). The fibronectin lane width at 10 μm was chosen to be smaller than a cell diameter in order to elicit cell confinement in the lane. A mechanically patterned topographical substrate with uniform fibronectin coating was the mechanical topography baseline, a smooth substrate with fibronectin lanes separated by EG₃-functionalized regions was the chemical pattern baseline, and a smooth substrate with uniform fibronectin coating was included as an unpatterned control. It was expected that for the combined samples, the orthogonal arrangement of mechanical topography and chemical patterns would induce a type of “tug-of-war” where cells aligned to the dominant pattern, thus illustrating the relative impact of each pattern on cellular alignment. Fibronectin lane spacings were chosen to be (i) less than the embossed groove spacing at 10 μm, (ii) similar to the groove spacing at 20 μm, (iii) larger than the groove spacing at 50 μm, and (iv) a distance for which cells are not able to span at 100 μm. Each configuration was analyzed in three separate experiments.

Cells were seeded and cultured on the patterned substrates and cell alignment was analyzed via microscopy and image analysis. After fixing and staining DNA with a fluorescent dye, the angle of the major axis of the elliptical cell nucleus was determined. Initial studies indicated that nuclear alignment angle gives a reliable and robust indication of overall cell alignment. The measurements of the magnitude of the nuclear alignment angle resulted in non-normal histograms with data ranging 0°-90°. For each substrate configuration, over 100 data points were analyzed using a Wilcoxon Rank sum test with p<0.05 considered statistically significant. Cell orientation was quantified by (i) the fraction of cells aligned to with 10° of the major substrate features, and (ii) the average alignment angle of cells on a given substrate type. Cells are strongly aligned when their nuclear orientation is close to the orientation of the substrate features. For each substrate configuration, average alignment angles of each replication do not differ significantly.

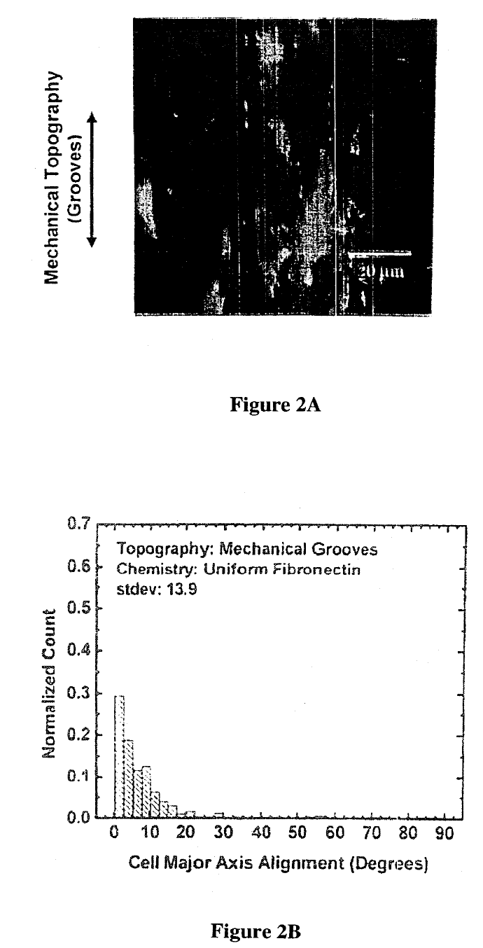

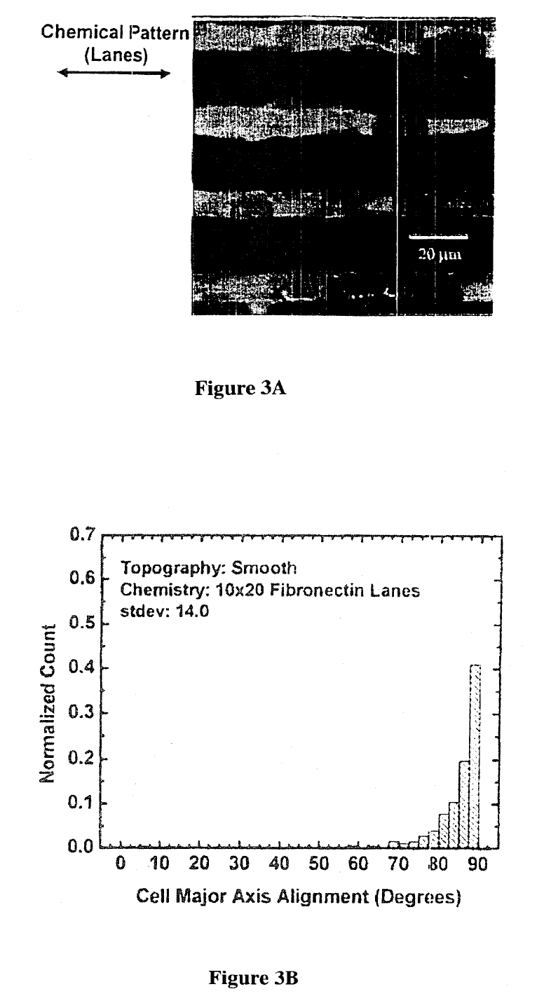

In order to determine baselines for the patterns having both mechanical topography and chemical patterns, baseline samples were prepared with mechanical topography only and with chemical patterns only. On the mechanical topography baseline, which had mechanical topography grooves and uniform surface chemistry, cells strongly aligned to the grooves. Over 73% of the cells aligned to with 10° of the mechanical topography and the average alignment angle was 9.6°, close to the mechanical topography oriented at 0°. On the chemical pattern baseline, which was smooth but printed with fibronectin lanes, more than 80% of the cells aligned to the chemical pattern and the average alignment angle was 81.9°, close to the chemical pattern orientation of 90°. The chemical pattern baseline result is in agreement with previous reports where chemical patterns confirmed cells and induced alignment. FIGS. 2 through 4 show cells on both baseline samples and a distribution of measured cell alignment on these samples. When presented alone, both the mechanical topography and the chemical pattern significantly influenced cell alignment (See FIGS. 2A and 3A, respectively). Table 1 summarizes average alignment angle and percentage of aligned cells.

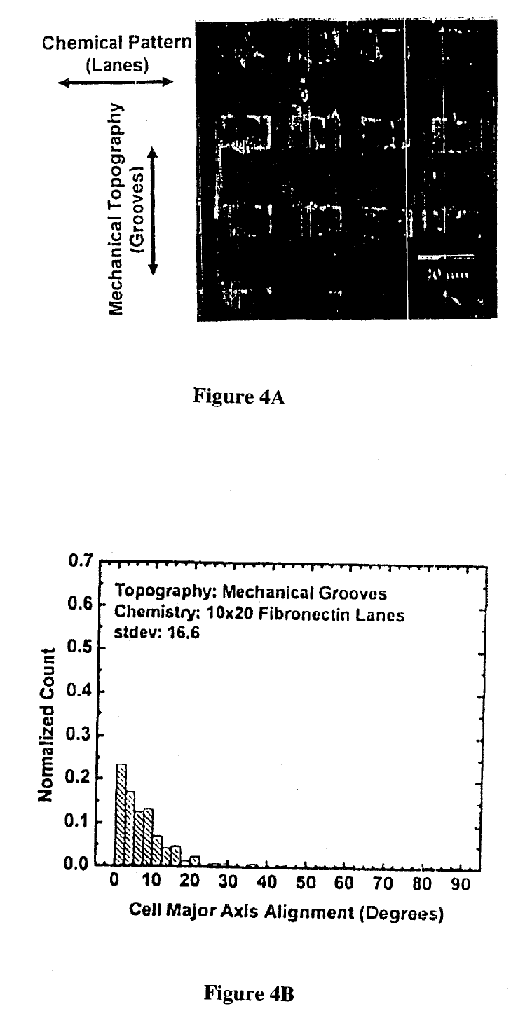

Cells were cultured on substrates having combined mechanical topography and chemical patterns in order to determine the relative impact of the two patterning methods on cell alignment (See FIG. 4A). The substrates had fibronectin lanes overlaid orthogonally to the mechanical grooves, with the same groove width and chemical lane width as the baseline samples. The cell alignment data is distributed such that alignment to the mechanical grooves occurs at 0° and alignment to the fibronectin lanes occurs at 90°. Remarkably, over 65% of cells aligned to the mechanical grooves rather than the fibronectin lanes. The average alignment angle was almost 12°, close to the mechanical baseline. The cell alignment angle was more broadly distributed than either baseline sample. Although the mechanical topography dominated the alignment over the chemical pattern, the presence of chemical pattern on the combined substrate influenced the fraction of cells aligned and average alignment angle.

To determine impact of chemical lane spacing on alignment, cells were cultured on substrates with the same topographical pattern as above but each with different fibronectin lane spacing. Table 1 shows a description of all substrate types and data for cell alignment and average angle. As spacing of the fibronectin lanes increased from 10 μm to 100 μm on grooved substrates, cells remained aligned to the grooves and average alignment angles for all combined substrates were similar. In all cases, regardless of chemical pattern spacing, the cells preferentially aligned to the mechanical grooves bridging up to 50 μm of non-adhesive EG₃-thiol to do so.

Although this study clearly showed the mechanical topography dominating the alignment mechanism over chemical patterns, other configurations could produce different results. In the configurations presented, the printed fibronectin lanes did not reach the bottom of the grooves, resulting in a discontinuous chemical pattern that may have affected the impact of the chemical patterns on cell alignment. Both mechanical topography spacing and depth can influence cell alignment and this could also affect cell response.

The invention is a method to manufacture substrates for cell culture with independently fabricated mechanical topography and chemical patterns. When presented with either the mechanical topography or the chemical lanes alone, the cells significantly aligned to the pattern presented. When presented with a combination of the features, the cells responded to and aligned preferentially with the mechanical features in every sample type considered. Future experiments will investigate the effects of size, shape, and spacing for both mechanical and chemical features on cellular adhesion, motility, and contact guidance. A wide range of polymer substrate materials could be employed and the technique is scalable to large surface areas suitable for culturing large cell populations. A key feature of the technique is its ability to independently control mechanical and chemical features on a surface, allowing progress towards questions regarding the relative impact of surface topography and chemical patterns on cell-substrate interaction.

### EXPERIMENTAL

For the mechanical topography, silicon masters were made using standard photolithography and deep reactive ion etching to a depth of 4 μm. The master vertical sidewalls smoothed growing thermal silicon dioxide that was then stripped. The microstructured polymer surfaces were prepared starting a 8.5 μm thick layer of polyimide from HD Microsystems, spin-coated onto a silicon wafer and soft-baked to purge the solvent. For embossing, a preload of <SN was applied while the temperature ramped to 150° C. The load was then increased to 1.8 kN and maintained for 10 minutes. The samples were allowed to cool, then separated. The substrates were baked until fully cured according to the manufacturer's specification. Using an electron beam evaporator, a 10 nm thick layer of titanium and then a 20 nm thick layer of gold were coated onto the substrate. The smooth substrates were prepared identically minus the embossing step.

The following is an example of a chemical pattern template. PDMS stamps were made from Sylgard 184 and 186 in a 5:1 ratio poured into microfabricated molds, purged of air in a vacuum, and cured according to the manufacturer's specification. Before μCP, the PDMS stamps and substrates were sonicated in 70% ethanol, dried under nitrogen, swabbed with HDT and dried under nitrogen again. After inking, the substrate was immersed in tri(ethylene glycol)-terminated alkanethiol for 2 hours. Samples were sterilized in 70% ethanol, and rinsed in PBS. The substrates were soaked in 10 μg/mL fibronectin solution for 30 minutes, blocked in 1% bovine serum albumin, then eluted in PBS for at least an hour.

MC3T3-E1 osteoblast-like cells were seeded at 450 cells/mm² on the substrates and cultured for 24 hours in α-minimal essential medium with 10% fetal bovine serum. For immunostaining, cells were permeabilized in 0.1% Triton X-100 and fixed in 3.7% formaldehyde. Samples were incubated in anti-fibronectin rabbit antibody for 1 hour followed by AlexaFluor488-conjugated anti-rabbit IgG antibody, Hoescht DNA stain, and rhodamine-phalloidin actin stain for 1 hour. A fluorescence microscope collected cell images. Each cell nucleus was fit with an ellipse, the major axis of which was used as the nucleus orientation, which was recorded with respect to the surface features. The sign of the alignment angle was arbitrary and only the magnitude was tabulated, resulting in a non-normal data distribution.

1. A method for fabricating a cell culture surface substrate, comprising the steps of
a) forming a cell culture surface having a mechanical topography;
b) forming a synthetic chemical pattern using a chemical pattern template; and
c) combining the cell culture surface having a mechanical topography and the synthetic chemical pattern;
wherein the mechanical topography is defined as a pattern of mechanical structures with regular and specifically designed features and the synthetic chemical pattern is defined as a group of features of specific chemistry different from the chemistry of their surroundings that have regular and specifically designed features.

2. The method of claim 1, wherein the cell culture surface substrate may be applied to orthopaedic implants, biosensors, and drug delivery devices.

3. The method of claim 1, wherein the cell culture surface substrate is an orthopaedic implant, a biosensor, or a drug delivery device.

4. The method of claim 1, wherein the mechanical topography further comprises grooves, mesas, ridges, wells, nodes, pillars, pores, spheres, and cylinders.

5. The method of claim 1, wherein the step of providing a cell culture surface having a mechanical topography comprises forming the mechanical topography using hot-embossing imprint lithography.

6. The method of claim 1, wherein the step of providing a synthetic chemical pattern comprises transferring a chemical pattern onto the substrate using microcontact printing.

7. The method of claim 1, wherein step a) is performed prior to step b).

8. The method of claim 1, wherein step b) is performed prior to step a).

9. A method for fabricating a cell culture surface substrate having a mechanical topography overlaid with a synthetic chemical pattern, comprising the steps of:
producing microscale mechanical topography in a polymer substrate and thereafter transferring a synthetic chemical pattern onto the substrate;
wherein the microscale mechanical topography and the synthetic chemical pattern are formed independently of each other.

10. The method of claim 9, wherein the microscale mechanical topography is formed using hot-embossing imprint lithography.

11. The method of claim 10, wherein the hot-embossing imprint lithography may replicate features 10 nanometers or larger.

12. The method of claim 9, wherein the substrate is etched following the step of transferring a synthetic chemical pattern onto the substrate.

13. The method of claim 12, wherein the substrate is thereafter derivatized.

14. The method of claim 9, further comprising the step of seeding cells on the cell culture surface substrate following the step of transferring a synthetic chemical pattern onto the substrate.

15. A method for fabricating a cell culture surface substrate, comprising the steps of:
a) producing microscale mechanical topography in a polymer substrate via hot-embossing imprint lithography; and
b) transferring a synthetic chemical pattern onto the substrate via microcontact printing.

16. The method of claim 15, wherein the step of producing microscale mechanical topography comprises features 10 nanometers or larger.

17. The method of claim 15, further comprising the step of coating the embossed polymer substrate with metal prior to transferring a synthetic chemical pattern onto the substrate.

18. The method of claim 17, wherein the metal is titanium, platinum, or gold.

19. The method of claim 15, wherein the step of transferring a synthetic chemical pattern onto the substrate comprises using poly(dimethylsiloxane) stamps having the desired pattern swabbed with hexadecanethiol.

20. The method of claim 15, wherein the synthetic chemical pattern comprises fibronectin, polyethylene glycol, and self assembled monolayers.
